(19) United States
(12) Patent Application Publication
(10) Pub. No.: US 2005/0038792 A1
(43) Pub. Date: Feb. 17, 2005

(54) Apparatus and method for operating circular files

(76) Inventor: Ted C. Johnson, Issaquah, WA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/640,902

(22) Filed: Aug. 14, 2003

(51) Int. Cl. G06F 17/00

(52) U.S. Cl. 707/100

(57) ABSTRACT

The disclosed embodiments relate to a system for operating circular files. The system comprises a program designed to write data to a flat file, a pipe having a name corresponding to the flat file and a process that receives the data from the pipe and directs the data to a circular file. The operation of the circular file is transparent to the program.

### BACKGROUND OF THE RELATED ART

This section is intended to introduce the reader to various aspects of art, which may be related to various aspects of the present invention that are described and/or claimed below. This discussion is believed to be helpful in providing the reader with background information to facilitate a better understanding of the various aspects of the present invention. Accordingly, it should be understood that these statements are to be read in this light, and not as admissions of prior art.

Log files are created in computer systems to keep track of a variety of system information such as business metrics, diagnostics, system problems and the like. In large computer networks, log files take up a considerable amount of disk storage space. In many systems, log files are stored in flat files that continue to expand as data is added. One of the chronic causes for system failures is that disks fill up, causing the computer system to be unable to function. One cause of disks becoming full is that application logs may accumulate more information than expected. In such cases, other processes are not able to create files needed to continue internal processing. Log file trimming scripts (which may be executed under control of a clock daemon such as cron in a Unix computing environment) inevitably fall behind as system usage grows beyond original estimates. Even if the frequency of log trimming utilities is increased, system usage tends to overrun the ability of the log trimming utilities to keep up in the long run.

A potential solution to the problem of log file overflow is the use of circular log files. Circular files have a fixed size and are structured such that older information is overwritten automatically when the file fills up, without expanding the size of the file. Information is maintained in a circular file in a first-in, first-out (“FIFO”) basis. Thus, circular files never overflow their disk, and they always have the latest information. Many application programs, however, do not make use of circular log files. Without the source code of a given application program, it is not practical to retrofit the program to implement circular log files. Even if source code for a given application program is available, programmers may lack the expertise to replace all the standard file write calls (e.g., printf(3)), with calls to newly created circular file write routines.

### SUMMARY OF THE INVENTION

The disclosed embodiments relate to a system for operating circular files without access to application source code. The system comprises a program designed to write data to a flat file, a pipe having a name corresponding to the flat file and a process that receives the data from the pipe and directs the data to a circular file. The operation of the circular file is transparent to the program.

### BRIEF DESCRIPTION OF THE DRAWINGS

Advantages of one or more disclosed embodiments may become apparent upon reading the following detailed description and upon reference to the drawings in which:

FIG. 1 is a block diagram illustrating the use of a flat log file by an application program;

FIG. 2 is a block diagram illustrating the use of a retrofittable circular log file in accordance with an embodiment of the present intention;

FIG. 3 is block diagram illustrating the flow of data in a retrofittable log file in accordance with an embodiment of the present invention; and

FIG. 4 is a block diagram of a system that may employ embodiments of the present invention.

### DETAILED DESCRIPTION

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

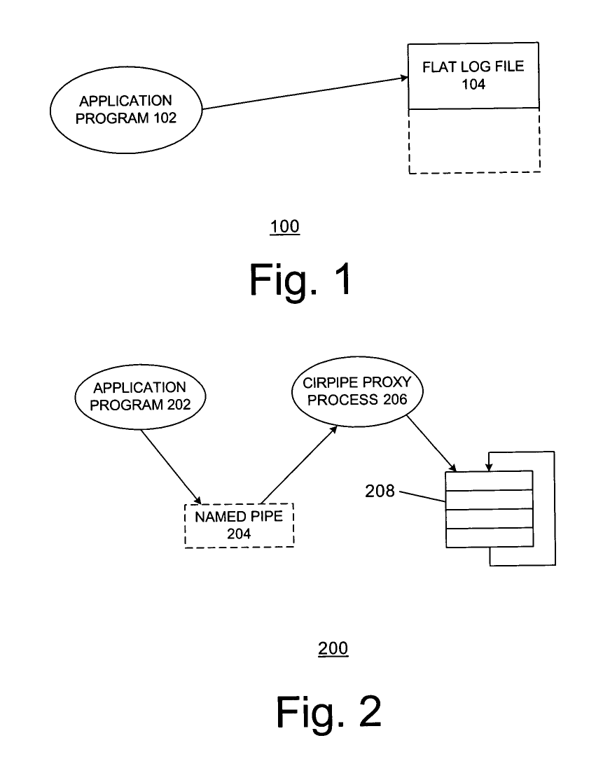

FIG. 1 is a block diagram illustrating the use of a flat log file by an application program. The diagram is generally referred to by the reference numeral 100. An application program 102, which executes on a computer system, creates a flat log file 104 to record log data. As indicated by the dashed lines in FIG. 1, the flat log file 104 continues to expand in size as new data is added. Log trimming utility programs are typically unable to keep up with the growth of the flat log file 104 over a long period of time. The result is that the flat log file 104 may continue to expand until the disk which holds the flat log file 104 is full. This may result in serious performance problems for a computer system in which the disk resides. The use of circular log files having a fixed size is explained below with reference to FIG. 2.

FIG. 2 is a block diagram illustrating the use of a retrofittable circular log file in accordance with an embodiment of the present intention. The diagram is generally referred to by the reference numeral 200. An application program 202, which executes on a computer system, may be designed to write to a flat log file such as the flat log file 104 of FIG. 1. The flat log file that the application program 202 is intended to write to may, however, may be removed and replaced with a “named pipe” 204 having the same name as the target flat log file. The named pipe 204 is shown by the dashed lines in FIG. 2 to signify the removal of the associated flat log file and substitution for a named pipe having the same name.

To the application program 202, writing to the named pipe 204 is identical to writing to a standard log file, so no changes to the coding of the application program 202 are needed. On the other end of the named pipe 204, a circular pipe proxy process (shown as “cirpipe proxy”) 206 reads data intended to be stored in the log file, and writes the data to a circular file 208. Thus, there is no longer a need for a flat log file, which is transparently replaced with a circular file.

The substitution of the circular file for the expanding flat file solves the problem of log files filling up a disk in a computer system without requiring access to the source code of application programs or recompiling the application program. Embodiments of the present invention may be implemented on any Unix or Linux system. Additionally, the invention is applicable to certain PC systems that use the NTFS file system or the like. Examples of operating systems that may employ the NTFS file system include Windows NT, Windows 2000, Windows XP and the like. Those of ordinary skill in the art will appreciate that the invention may be applicable to computer systems that employ other operating systems as well.

The “cirpipe” proxy process 206 receives as arguments the information it needs to create and write to the circular file 208. Those arguments may include a pathname to the named pipe, a pathname to the circular file 208, the maximum number of records to use for circular file and the like.

In a Unix environment, the following process may be used to replace a flat file with a circular file. For purposes of illustration only, the following examples refer to a Weblogic J2EE (Java 2 Enterprise Edition) application server program and the logs created by that program.
1. Delete the flat log file:
   $ rm/opt/weblogic/logs/error.log
2. Replace the flat file with a Unix-named pipe of the same name:
   $ mkpipe/opt/weblogic/logs/error.log
3. Launch the “cirpipe” proxy to read from the named pipe and write to the circular file. A maximum file size may be chosen by specifying the maximum number of records (max_no_records) for the circular file. To choose a file size of 128 k, input 100000 (i.e., 100 k 128-byte records):
   $ cirpipe/opt/weblogic/logsferror.log 100000

The record size of 128 bytes is arbitrary. Other record sizes may be chosen. The max_no_recs value may only be used internally for circular file pointer logic. An engineer or support person viewing the file with a circular file utility program (e.g, “circat file”) may have no visibility to the record size, as the printf(3) writes are flowed seamlessly across record boundaries. Thus, the resulting file appears identical to the flat file it replaces.

Embodiments of the present invention may make use of utility programs created by the software engineer such circat and cirtail, which are conversion utilities that correspond to the standard Unix cat(1) and tail(1) utilities. They are used to convert the circular file into a flat ASCII file. They may be built using the Predictive/UX Circular Files API. The following commands may be used to respectively convert a circular file into a flat file for processing and monitor it:
$ circat file
$ cirtail-f file
   As a specific example for the Weblogic application server, the following commands may be used to convert the circular file into a flat file for processing:
   $ circat/opt/weblogic/logs/error.log>/tmp/error.log
      To do real-time monitoring of the circular file, the following command may be used:
   $ cirtail-f/opt/weblogic/logs/error.log

The following command summary may be useful for creating and managing circular files in computing environments that employ operating systems such as an MPE XL or HP-UX. In MPE XL, the circular files are MPE circular files. In other Unix operating environments (for example, HP-UX), the circular files simulate MPE circular files. The following exported routines may comprise a library, which may be referred to as nslib.a:

| | |
|---|---|
| PSOpen_Circular() | Open the specified file, creating it if it does |
| | not exist. |
| PSWrite_Circular() | Write record to circular file; advance file pointer |
| PSClose_Circular() | Close the specified file. |
| PSCopy_Circular() | Copy the specified circular file. |

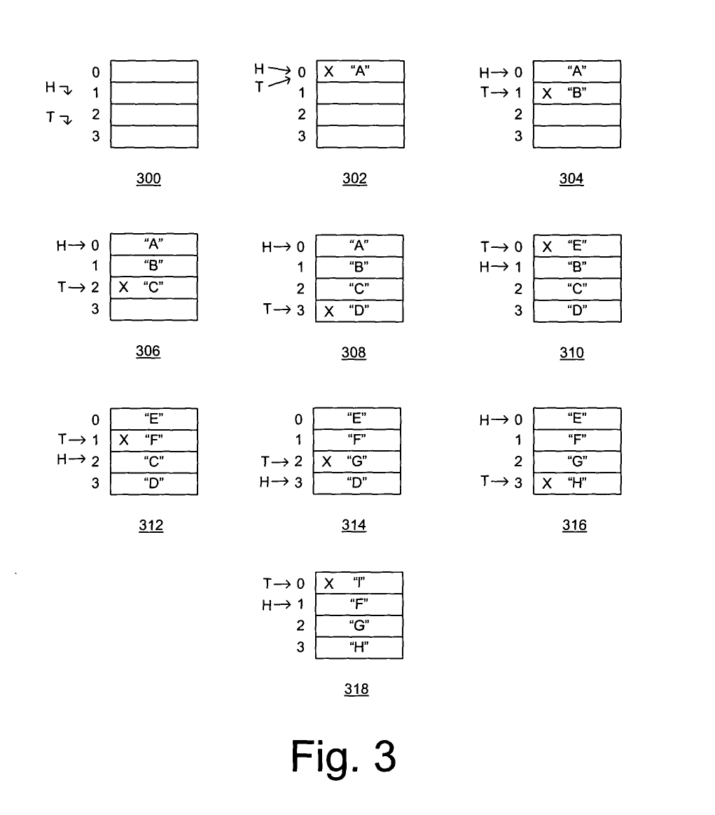

These commands may be used to provide circular file functionality for C and Pascal programs. Since HP-UX does not provide circular-files, the HP-UX version of this module simulates circular files with flat files. The operation of these flat files is explained with reference to FIG. 3.

FIG. 3 is block diagram illustrating the flow of data in a retrofittable log file in accordance with an embodiment of the present invention. The example shown in FIG. 3 includes four records.

Each flat file may comprise a header section and a data section. The length of the header section is static (PS_UX_HEADER_SIZE bytes). The data section is composed of logical records. The length of the data section is initially zero, but it will grow to (Rec_Size*Max_No_Rec), at which time it will begin to wrap around itself (by overwriting the oldest data record with the new data record). This is slightly different than an MPE circular file. In MPE, when a write is done into a full circular file, all the blocks of records are shifted back, losing the oldest block of records and creating an empty block of records. MPE loses the last blocking-factor (blocking-factor is >=1) number of records, whereas the HP-UX implementation only loses the oldest single record.

The circular file header may comprise the following components:
1. File_ID: Identifier which marks this as a PS-UX circular file (4 bytes).
2. Head Ptr: The logical record number of the first valid logical record; this is the head of the circular file (4 bytes).
   Range: 0-->(Max_No_Rec−1).
3. Tail_Ptr: The logical record number of the last valid logical record, this is the tail of the circular file (4 bytes)
   Range: 0-->(Max_No_Rec−1).
4. Rec_Size: Number of bytes in each record (4 bytes).
5. Num_Rec: Number of records currently in the circular file (4 bytes).
   Range: 0-->Max_No_Rec.
6. Max_No_Rec: Indicates the maximum number of records allowed in this file (4 bytes).
7. Binary_Ascii: Indicates the type of data in the data section (4 bytes).

The head pointer (head_ptr) points to the first valid logical record. The tail pointer (tail_ptr) points to the last valid logical record. Logical records are numbered from 0 to (Max_No_Rec−1).

The Num_Rec sets the number of physical records. Their numbers range from 0 to (Max_No_Rec−1). There are also Num_Rec logical records, and their numbers also range from 0 to (Max_No_Rec−1). The difference is that when overflow occurs, the physical record numbers do not shift, but the logical record numbers do. The current logical record 0 is indicated by the head pointer (head_ptr), and the current last logical record is indicated by the tail pointer (tail_ptr).

FIG. 3 illustrates the operation of the circular file of the present invention by showing an example of the circular file in successive states as data elements are added. Deletion of records is not allowed. The location of the head pointer (head_ptr) is illustrated by the letter “H” in FIG. 3 and the location of the tail pointer (tail_ptr) is illustrated by the letter “T” Elements of data that are added to the circular file illustrated in FIG. 3 are represented by letters of the English alphabet. In an initial state 300, the circular file is empty, so both head_ptr and tail_ptr contain INVALID_CIRC_FILE_PTR (which is equal to −1).

In the embodiment illustrated in FIG. 3, overflow is defined as the condition in which adding a record will cause us to overwrite an older record. Overflow will occur after there are already Max_No_Rec logical records in the circular file. When adding a record, there are three cases to consider. Case 1 is the addition of the first record to an empty circular file. A circular file may be identified as being empty if its Num_Rec variable is zero.

A first record is added in a state 302. As shown in state 302, the head pointer (head_ptr) is updated from its previously invalid value to a value of zero (0). Also, the tail pointer (tail_ptr) is updated from its previously invalid value to a value of zero (0). The Num_Rec variable is changed from zero (0) to one (1). The first record is written to logical record zero (0).

In case 2, the addition of a new record is not the first record in a circular file, nor will the addition of a new record cause an overflow condition. This case exists when the Num_Rec variable is between zero (0) and the value of the variable Max_No_Rec. When a record is added, as shown in cases 304, 306 and 308, the head pointer (head_ptr) remains pointing at logical record zero (0) while the tail pointer (tail_ptr) and the Num_Rec variables are each successively incremented.

For case 3, an addition of a new record will cause an overflow condition. The operation of an embodiment of the present invention with respect to case 3 is illustrated in states 310, 312, 314, 316 and 318 of FIG. 3. A write that will cause an overflow is indicated if the Num_Rec variable is equal to the Max_No_Rec variable. If an overflow is going to occur, both the head pointer (head_ptr) and tail pointer (tail_ptr) variables must be incremented. If either the head pointer (head_ptr) or tail pointer (tail_ptr) is pointing to the last record in the circular file, then that pointer wraps back to the lowest numbered logical record, as illustrated in the successive additions represented in states 310, 312, 314, 316 and 318 of FIG. 3. The Max_No_Rec variable is left unchanged and the actual write operation is performed on the record indicated by the tail pointer (tail_ptr) variable.

To read the records of a circular file created in accordance with an embodiment of the present invention in chronological order, the logical record indicated by the head pointer (head_ptr) should be read first. Successive reads should be directed to logical records in “forward order” (i.e., next_rec=(current_rec+1) (modulo Max_No_Rec)) until the logical record corresponding to the tail pointer (tail_ptr) is read.

Circular files that embody the invention may support multiple writers. Reading may be allowed while writing is being performed. Concurrency control may be provided by employing locked access to the circular file (e.g. a lockf(2) system call). Locking may be performed in “enforcement mode” as opposed to “advisory mode,” which only enforces locking between cooperating processes that check for locks). To activate enforcement mode locking a lock call may require that a set-group-id bit is set on the file (e.g., by using a “chmod g+s filename” in a Unix environment).

Embodiments of the present invention may employ FLOCK semantics of a locking call such as lockf(2). This means that any process that attempts to read(2) or write(2) a circular file will be put to sleep by the operating system if the lock is not available for that file (i.e., that file is locked by another process). If a file is not locked, any number of processes may read from it. Multiple readers and multiple writers can have concurrent access to a circular file, i.e. they can have the circular file open at the same time. With respect to MPE, the last blocking-factor worth of records are lost on overflow. In other environments such as the HP-UX environment, only the last record is lost.

The operation of circular files created in accordance with embodiments of the present invention differ from MPE circular file, where if a process can open(2) a circular file, that means that it can also write(2) to it. Embodiments of the present invention also guarantee that any process that opens a circular file will not fail when it attempts to write to it. However it may temporarily put a process to sleep if another process has the file locked. When the file is unlocked, the sleeping process will be awakened by the kernel, and allowed to continue its operation.

A module that implements circular files according to the present invention may perform locking for readers and writers. In order to permit a consistent report to be written while at the same time allowing writers to write new records, a new call may be implemented. That call may be entitled PSCopy_Circular( ) and it may copy the data from a circular file to a new (temporary) ordinary flat file (whose name specified is specified by the user). PSCopy_Circular( ) can copy the data in either chronological order or reverse chronological order.

The following is an example of how program calls may be implemented to write to a circular file created in accordance with embodiments of the present invention:
PSOpen_Circular ( )
PSWrite_Circular( ) (zero or more times]
PSClose_Circular ( )
   For reading, an example of the order of operations is:
PSOpen_Circular ( )
PSCopy_Circular ( )
PSClose_Circular ( )
   Processing may be done on the flat file copy. However most of the time processing will be done via the “circat” and “cirtail” utilities, e.g., “circat circularfile>/tmp/flatfile”, or “cirtail-f file” to monitor a circular file.

The only procedures that lock the circular file are PSWrite_Circular( ) and PSCopy_Circular( ). While these two procedures are active, no other processes may access (read or write) the circular file.

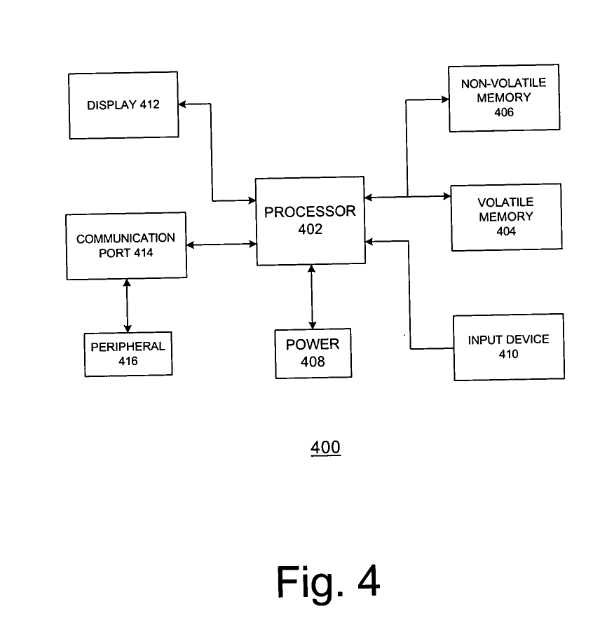

FIG. 4 is a block diagram of a system that may employ embodiments of the present invention. The system, which is generally referred to by the reference numeral 10, may be any of a variety of types such as a computer, pager, cellular phone, personal organizer or the like. In a processor-based device, a processor 402, such as a microprocessor, may control the operation of system functions and requests. In particular, the processor 402 may execute the process that redirects input to the circular pipe proxy process previously described.

The processor 402 may be coupled to various types of memory devices to facilitate its operation. For example the processor 402 may be connected to a volatile memory 404 and a non-volatile memory 406. The volatile memory 404 may comprise a variety of memory types, such as static random access memory (“SRAM”) or dynamic random access memory (“DRAM”) or the like. The non-volatile memory 406 may comprise various types of memory such as electrically programmable read only memory (“EPROM”), hard drive storage and/or flash memory or the like. Those of ordinary skill in the art will appreciate that any give system 400 may employ several types of volatile memory devices 404 and non-volatile memory devices 406. Either the volatile storage 404 or the non-volatile storage 406 may be used to store the circular files described above with reference to FIG. 2 and FIG. 3.

The system 400 may include a power supply 408, which may comprise a battery or batteries, an AC power adapter and/or a DC power adapter. Various other devices may be coupled to the processor 402 depending on the functions that the system 400 performs. For example, an input device 410 may be coupled to the processor 402 to receive input from a user. The input device 410 may comprise a user interface and may include buttons, switches, a keyboard, a light pen, a mouse, a digitizer and/or a voice recognition system or the like. An audio or video display 412 may also be coupled to the processor 402 to provide information to the user.

A communications port 414 may be adapted to provide a communication interface between the system 400 and peripheral devices 416. The peripheral devices 416 may include a docking station, expansion bay or other external component.

The processor 402, the non-volatile memory 406 and the volatile memory 404 may be implemented as one or more integrated circuit components. Also, the processor 402, the non-volatile memory 406, and the volatile memory 404 are examples of integrated circuit components that may include sense amplifier circuits constructed in accordance with embodiments of the present invention.

While the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the following appended claims.

1. A system for operating circular files, comprising:
a program adapted to write data to a flat file;
a pipe having a name corresponding to the flat file; and
a process that receives the data from the pipe and directs the data to a circular file, wherein the operation of the circular file is transparent to the program.

2. The system set forth in claim 1, wherein the process is adapted to employ a head pointer to identify a first record in the circular file.

3. The system set forth in claim 2, wherein the process is adapted to employ a tail pointer to identify a last record in the circular file.

4. The system set forth in claim 1, wherein the process is adapted to allow multiple writers to write data to the circular file.

5. The system set forth in claim 4, wherein the process is adapted to lock the circular file when data is being written thereto.

6. The system set forth in claim 1, wherein the process is adapted to allow multiple readers to read data from the circular file.

7. The system set forth in claim 1, wherein the circular file comprises a log file.

8. A method for operating a circular file in a computer system, the method comprising the acts of:
writing data to a pipe having a name that previously corresponded to a flat file; and
directing the data written to the pipe to a circular file.

9. The method set forth in claim 8, comprising the act of allocating a maximum size for the circular file.

10. The method set forth in claim 8, comprising the act of allocating a maximum number of records that may be stored in the circular file.

11. The method set forth in claim 8, comprising the act of identifying a first record in the circular file with a head pointer.

12. The method set forth in claim 8, comprising the act of identifying a last record in the circular file with a tail pointer.

13. The method set forth in claim 8, comprising the act of allowing multiple writers to write data to the circular file.

14. The method set forth in claim 8, comprising the act of locking the circular file when data is being written thereto.

15. The method set forth in claim 8, comprising the act of allowing multiple readers to read data from the circular file.

16. A method for transparently replacing a flat file with a circular file, the method comprising the acts of:
deleting the flat file;
creating a pipe having a name corresponding to the flat file; and
providing a process that is adapted to receive data from the pipe and write the data to a circular file.

17. The method set forth in claim 16, comprising the act of specifying a maximum size for the circular file.

18. The method set forth in claim 17, comprising the act of specifying a maximum number of records for the circular file.

19. The method set forth in claim 16, comprising the act of identifying a first record in the circular file with a head pointer.

20. The method set forth in claim 16, comprising the act of identifying a last record in the circular file with a tail pointer.

21. A computer system that supports the operation of circular files, the computer system comprising:
means for replacing a flat file, the means for replacing the flat file operating as a circular file; and
means for redirecting input directed to the flat file to the means for replacing the flat file, wherein the operation of the means for replacing the flat file is transparent to the system.
